(19) United States
(12) Patent Application Publication
(10) Pub. No.: US 2013/0249133 A1
(43) Pub. Date: Sep. 26, 2013

(54) METHOD OF PRODUCING SYNTACTIC FOAM

(71) Applicants: Majdi Haddad, Peabody, MA (US); Lou Watkins, Stoughton, MA (US)

(72) Inventors: Majdi Haddad, Peabody, MA (US); Lou Watkins, Stoughton, MA (US)

(21) Appl. No.: 13/426,122

(22) Filed: Mar. 21, 2012

(51) Int. Cl. B29C 44/12

(52) U.S. Cl. 264/45.3

(57) ABSTRACT

A method of manufacturing syntactic foam comprises mixing a non-liquid amine adduct and a liquid epoxy to form a matrix. Hollow microspheres are added to the mixture and mixed together to form a mixture, which may then be poured into a mold and heated to form a molded syntactic foam component.

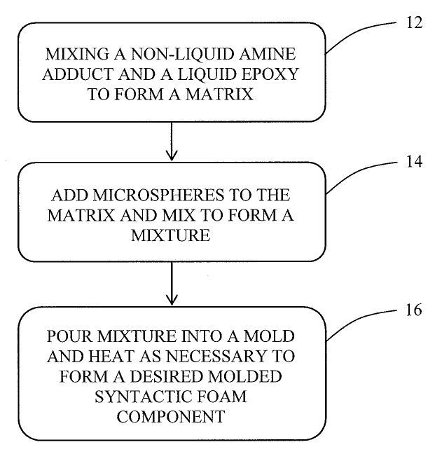

### BACKGROUND OF THE INVENTION

The invention relates to the field of syntactic foam, and in particular a method of manufacturing syntactic foam.

Syntactic foam is known for use for example in flexible marine risers for offshore oil exploration and gas production, and buoyancy modules. Syntactic foam typically includes a composite of hollow spherical fillers (e.g., glass microspheres) in a polymeric (e.g., epoxy) binder. The binder is typically a mixture of liquids which, when mixed together under correct conditions, solidify to form a rigid mass. Liquid epoxy ingredients typically include an “accelerant” added to initiate polymerization and accelerate the exothermic heat generation that aids in solidification. The term “catalyst” is often used to describe the accelerant, although “hardener” is actually a more accurate term. The use of liquid accelerants presents certain problems, including: (1) the necessity of quickly and thoroughly mixing a relatively small amount of material in a very large mass, and (2) the fact that exothermic rise begins immediately upon introduction of the “catalyst.” For use in making large buoys for offshore applications, the formulation of these ingredients must be carefully managed to provide adequate strength while avoiding excessive exotherm and curing shrinkage that can lead to cracking and degradation of properties.

There is a need for a method of preparing the polymeric binder system of syntactic foam that is less susceptible to cracking or degradation of properties.

### SUMMARY OF THE INVENTION

Briefly, according to an aspect of the present invention, a method of manufacturing syntactic foam comprises mixing a non-liquid amine adduct and a liquid epoxy to form a matrix, mixing the matrix and hollow microspheres to form a mixture, and introducing the mixture to a mold and heating the mixture to form a molded syntactic foam component.

The non-liquid amine adduct may be a powder, and comprises an amine in a high molecular weight solid form. The powder may be blended into the liquid epoxy at an early stage, which facilitates a thorough and complete mixing. The non-liquid amine adduct will not initiate chemical reaction until melted and activated by heat, which makes the casting process more controllable. The onset of solidification is delayed, so the ingredients remain as low-viscosity liquids longer, resulting in improved wet-out of glass cloth, macrospheres, and other dry constituents.

In another embodiment, the non-liquid amine adduct may be a capped secondary amine or a tertiary amine and include at some stage, a halogen such as a bromine

These and other objects, features and advantages of the present invention will become apparent in light of the following detailed description of preferred embodiments thereof, as illustrated in the accompanying drawings.

### BRIEF DESCRIPTION OF THE DRAWING

The FIGURE is a flow chart illustration of a process for manufacturing syntactic foam.

### DETAILED DESCRIPTION OF THE INVENTION

The FIGURE is a flow chart illustration of a process 10 for manufacturing syntactic foam. The process includes a step 12 of mixing a non-liquid amine adduct and a liquid epoxy to form a matrix. The non-liquid amine adduct may be provided in the form of a powder and comprise some or all of the ingredients listed above. The liquid epoxy may include for example Bisphenol-A, epoxy resin with a suitable diluent among other ingredients. Mixing of the amine adduct and the liquid epoxy may be performed by mixing at room temperature for about 15 minutes. The mixing of step 12 provides a matrix, to which microspheres are added in step 14 and mixed to form a mixture. In one embodiment the relative weight of the ingredients of the mixture are identified in Table 1. One skilled in the art will recognize that numerous other embodiments and ingredients are possible.

TABLE 1

| | RANGE | |
|---|---|---|
| INGREDIENTS | (parts-by-weight) | |
| Bisphenol-A Epoxy | 100 | pbw |
| Resin | | |
| Glass Microspheres | 20 to 30 | pbw |
| Amine Adduct | 1 to 5 | pbw |

The mixture from step 14 is then poured into a mold in step 16 and heated as necessary to form a desired molded syntactic foam component. The resultant syntactic foam component may be used for riser modules, fairings, riser drag reduction devices, distributed buoyancy, ROV floats, et cetera.

Although the present invention has been shown and described with respect to several preferred embodiments thereof, various changes, omissions and additions to the form and detail thereof, may be made therein, without departing from the spirit and scope of the invention.

What is claimed is:

1. A method of manufacturing syntactic foam, comprising:
mixing a non-liquid amine adduct to a liquid epoxy to form a matrix;
mixing the matrix and hollow microspheres to form a mixture; and
introducing the mixture to a mold and heating the mixture to form a molded syntactic foam component.

2. The method of claim 1, wherein the amine adduct comprises a capped secondary amine or a tertiary amine and include at some stage, a halogen such as bromine.

3. The method of claim 1, wherein the amine adduct is a powder.

4. The method of claim 2, wherein the liquid epoxy comprises Bisphenol F, phenolic resins, and diluted formulas for viscosity control.

5. The method of claim 4, wherein the microspheres comprise glass microspheres.

6. The method of claim 4, wherein the microspheres comprise a wall thickness of about 0.5 to 3.0 microns.
